(19) United States
(12) Patent Application Publication
(10) Pub. No.: US 2012/0244324 A1
(43) Pub. Date: Sep. 27, 2012

(54) Thermo-pressed cushioning support device

(76) Inventor: Fu-Chieng CHEN, Taipei (TW)

(21) Appl. No.: 13/069,914

(22) Filed: Mar. 23, 2011

(51) Int. Cl. B32B 3/18

(52) U.S. Cl. 428/178

(57) ABSTRACT

A thermo-pressed cushioning support device includes a topping sheet of cushioning material, a substrate sheet of cushioning material and at least a padding attached between the topping sheet of cushioning material and the substrate sheet of cushioning material. The padding undergoes an external force pressing treatment along with the topping sheet and the substrate sheet in a high temperature condition, melting and mating the topping and the substrate sheets into one entity. The heat treatment creates thermo-binding lines or regions of geometric patterns on the topping sheet, and also internal pockets within the topping sheet, where the padding is enclosed in such a way to provide impact reducing and shape modeling effects intended for the present invention. Embodiments of the thermo-pressed cushioning support, such as seat cushion, back cushion, couch cushion, or mattress topper, provide benefits to the user's body that include reduced anxiety, decreased perception of impact force, and collision prevention.

### FIELD OF THE INVENTION

The present invention generally relates to a thermo-pressed cushioning support device, particularly to a cushioning support device manufactured under the benefits of a thermo-pressing treatment that disposes at least one support padding into pockets formed between a topping sheet of cushioning material and a substrate sheet of cushioning material, for a purpose of providing effective body support to its user including reducing anxiety on occasions when the invention is used in some exemplary embodiments such as mattress stopper, seat cushion, back cushion, or couch cushion.

### BACKGROUND OF THE INVENTION

Currently, a variety of commercially available seat cushions and back cushions are well known in their design to include a foam piece and a fabric piece combined together through an external force pressing process under high temperature conditions. There are two notable problems with the product made from this manufacturing method. On the one hand, when the foam piece tends to be thick, the product's buffering functionality is limited, and thereby resulting in sore experience. On the other hand, when the foam piece tends to be soft, the well-perceived elastic buffering functionality is compromised by making the user's body more susceptible to be caught up in the foam, thereby raising inconvenience for the user.

In view of these, prior technology has attempted to use needle sewing as a means to combine cushioning materials and fabric layers in order to enhance the buffering functionality of the cushioning support product. Although such method of combination is capable of reducing degrees of collision and enhance ways to prevent such collision, there raises problems wherein the friction between user's skin and the woven works, resulting in skin ache or swollen skin, and not to excluding skin wound or inflammation. Furthermore, the apparent woven works on the fabric surface is prone to wane down consumer's purchasing desire in terms of product appearance and functionality.

In addition to the aforementioned drawbacks, cushioning support device made from needle sewing has been observed to have the problems of easier release or break-off of the woven works, thereby leading to displacement of the cushioning material, and therefore causing inconvenience to the consumers. Indeed, the displacement of the cushioning material can significantly lower the cushioning material's desired benefits to the user's body parts.

Taking these considerations into account, a preferred solution should be one that offers a cushioning support device made by a thermally pressed treatment wherein shock absorbing or modeling compounds are combined together with the support device. Such product can not only provide a more tightly held assembly and more comfortable support, but also cushioning materials configured in protruding forms to support user's body.

### SUMMARY OF THE INVENTION

It is therefore the object of this invention to provide a thermo-pressed cushioning support device. Said present invention uses a thermo-pressing treatment as a means to combine together a plurality of shock absorbing compound or modeling compound within the internal pockets housed between a topping sheet of cushioning material and a substrate sheet of cushioning material.

Another object of this invention is to provide a thermo-pressed cushioning support device incorporating a covering sheet. Said covering sheet is applied upon the topping sheet of cushioning material. The covering sheet can be made from a fabric, allowing for higher marketability.

Another object of this invention is to provide a thermo-pressed cushioning support device, wherein the topping sheet of cushioning material and the substrate sheet of cushioning material can be used as a storage pouch, and can be covered with a wrapping layer. The wrapping layer is detachable for cleaning.

The thermo-pressed cushioning support device capable of satisfying the above objects comprises the topping sheet of cushioning material and the substrate sheet of cushioning material and at least one padding, wherein, the padding is inserted in a prescribed location between the topping sheet and the substrate sheet. Thermo-pressing treatment operates to act upon predetermined locations on the topping sheet and the substrate sheet, and such locations are placed in the neighborhood of the padding. Such configuration ensures that the padding is free from the mechanical compression of the thermo-pressing treatment. Furthermore, the thermo-pressing treatment ensures that the locations where the pressing effectuates is melted and tightly bound together, which also produces depressed thermo-pressing regions. After the entire support device solidifies, the topping sheet and the substrate sheet are closely attached together, and an internal pocket is formed to house the padding; when the present invention is used as mattress topper, seat cushion, or back cushion, the tension and collision set off by the user's sitting down and laying upon the support device can be offset by the functionalities provided by the padding and the internal pockets, including support, shock absorbance, tension reduction, and molding.

### BRIEF DESCRIPTION OF THE DRAWINGS

The invention will be explained in more detail hereinafter with reference to illustrated in the figures. Like or comparable components are identified by like reference numerals, wherein:

FIG. 1 is a cross-sectional illustration showing component configuration showing elements of an embodiment of a thermo-pressed cushioning support device engaged with a thermo-pressing apparatus;

FIGS. 2A, 2B are elevational schematic diagrams of a first preferred embodiment of the thermo-pressed cushioning support device;

FIG. 3 is a cross-sectional perspective diagrammatic view of the component configuration of the first preferred embodiment of the thermo-pressed cushioning support device;

FIG. 4 is a cross-sectional diagrammatic view of a second embodiment of the component configuration of the thermo-pressed cushioning support device;

FIG. 5 is a cross-sectional diagrammatic view of a third embodiment of the component configuration of the thermo-pressed cushioning support device;

FIG. 6 is an elevational perspective diagram of a fourth embodiment of the component configuration of the thermo-pressed cushioning support device;

FIGS. 7A, 7B show perspective views of the thermo-pressed cushioning support device embodied in a first and a second form of a seat cushion;

FIG. 8 shows a perspective view of a couch cushion manufactured from the thermo-pressed cushioning support device;

FIGS. 9A, 9B, 9C, 9D show perspective views of a back cushion manufactured from the thermo-pressed cushioning support device; and

FIG. 10 shows a perspective view of a mattress topper manufactured from the thermo-pressed cushioning support device.

### DETAILED DESCRIPTION OF THE PREFERRED EMBODIMENTS

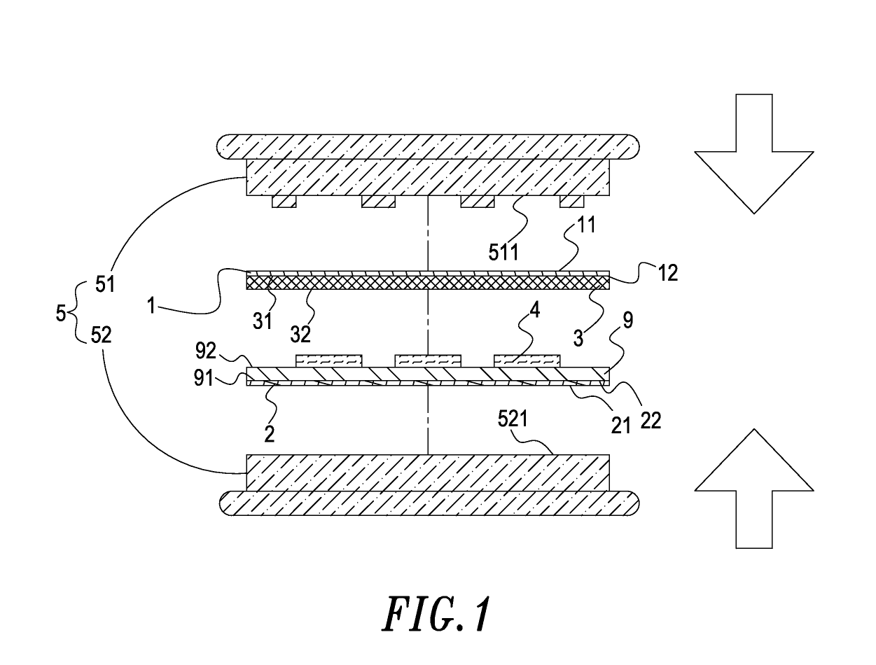

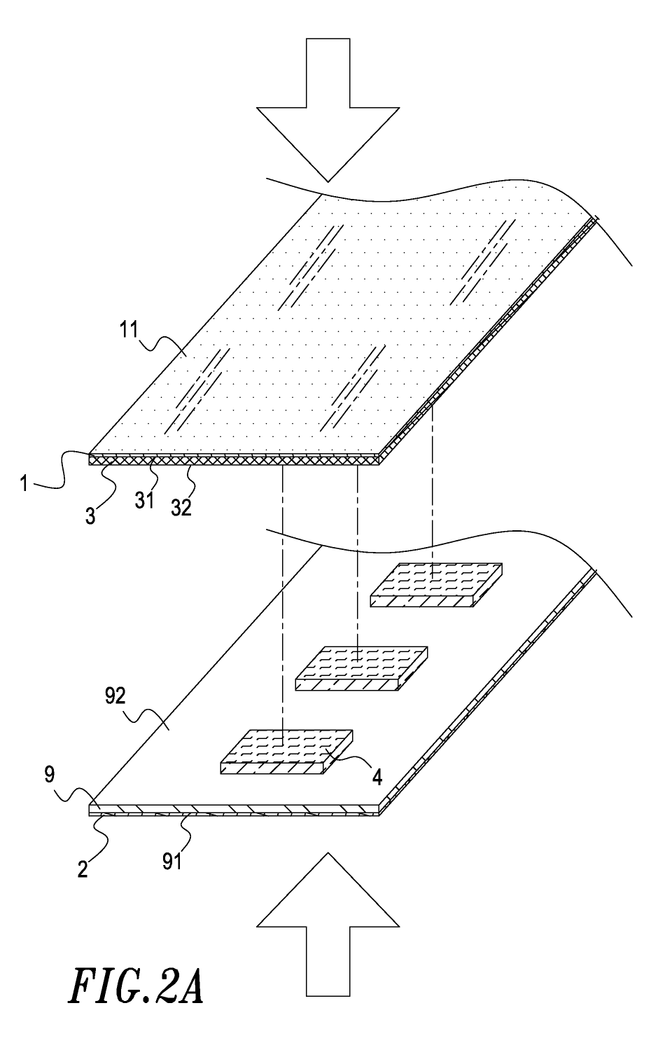

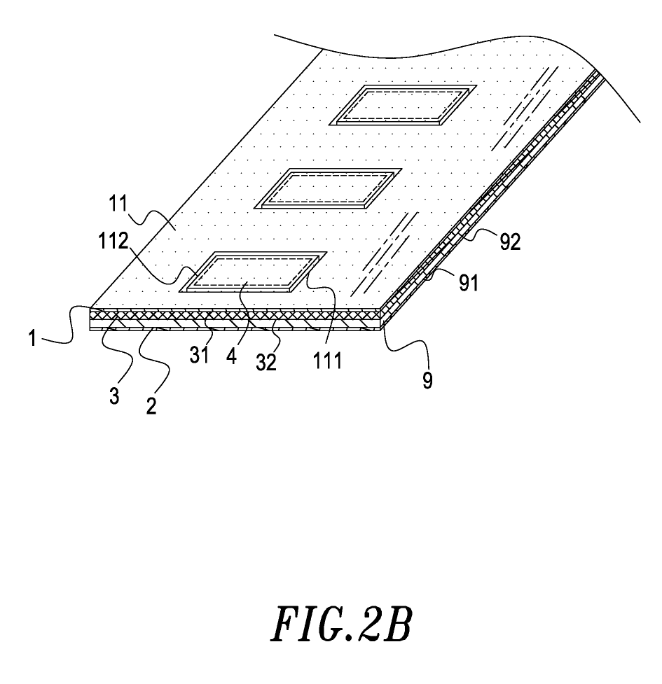

Referring to the drawings, FIGS. 1, 2A, 2B, and 3 shown therein are a diagrammatic perspective view showing the engagement of the respective components of the first preferred embodiment of the thermo-pressed cushioning support device with those of a thermo-pressing apparatus, an elevational schematic diagram, an elevational perspective diagram, and a cross-sectional perspective diagram of the present invention in its first preferred embodiment form. The foregoing figures show that the thermo-pressed cushioning support device comprises:

a covering sheet 1, wherein the covering sheet has a first major surface 11 and a second major surface 12, and the first major surface 11 of the covering sheet 1 has a tufted surface;

a topping sheet of cushioning material 3, wherein the topping sheet of cushioning material has a first major surface 31 and a second major surface 32, wherein the second major surface 32 of the covering sheet 1 is attached onto the first major surface 31 of the topping sheet of cushioning material 3;

a non-slip sheet 2, wherein the non-slip sheet has a first major surface 21 and a second major surface 22, wherein the first major surface 21 of the non-slip sheet 2 is slip resistant;

a substrate sheet of cushioning material 9, wherein the substrate sheet of cushioning material has a first major surface 91 and a second major surface 92, wherein the second major surface 22 of the non-slip sheet 2, is attached onto the second major surface 92 of the substrate sheet of cushioning material 9;

at least one padding 4, which is attached onto a predetermined location situated between the second major surface 32 of the topping sheet of cushioning material 3 and the first major surface 91 of the substrate sheet of cushioning material 9.

As per manufacturing the thermo-pressed cushioning support device, the foregoing covering sheet 1, topping sheet of cushioning material 3, non-slip sheet 2, substrate sheet of cushioning material 9, and padding 4 are bound together through a thermo-pressing treatment that subjects thermo-pressing apparatus 5 on the first major surface 11 of the covering sheet 1 and the first major surface 21 of the non-slip sheet 2 to a heat pressing process which performs the binding around the neighborhood of the padding 4, causing the topping sheet of cushioning material 3 and the substrate sheet of cushioning material 9 to be melted and melded together. Until about the temperature condition cools off, thermo-binding lines or regions of geometric shapes 111 are formed on the covering sheet 1 and the topping sheet of cushioning material 3 in addition to internal pockets 112 formed therefrom, wherein support padding 4 is enclosed.

In one notable aspect, the covering sheet 1 is made from fabric, linen, or leather.

In another notable aspect, the non-slip sheet 2 is used for the purpose of reducing a prescribed slippery condition, and the non-slip sheet 2 is made from fabric, linen, leather, or a similar non-slip material that can provide the same slipperiness-reduction functionality.

Furthermore, the topping sheet of cushioning material 3 and the substrate sheet of cushioning material 9 are made from polyurethane (PU) foam. The PU foam has a chemical property of turning liquid and viscous when heated to an elevated temperature. This property gives benefit to tightly glue together the topping sheet of cushioning material 3 and the substrate sheet of cushioning material 9, and allows for moldable depression on the topping sheet 3 and the substrate sheet 9 as the PU foam cools down on locations where deformations are created post the thermo-pressing treatment. The solidified PU foam stays in this structural configuration after the cooling.

In another notable aspect, the padding 4 is made from gels, latex, silica gels, or other elastomeric materials so as to enabling the padding 4 ability to distribute any perceived applied impact, and therefore offering an embodiment of the present invention that is supportive, capable of absorbing mechanical vibration, dispersing external pressure, and buffering impact. Furthermore, the foregoing elastomeric materials can be prepared in various surface pattern configurations depending on consumers' request, such as spider-webs, gridlines, blocks, perforations, raised-bubbles or embossed indentions.

In another aspect, the padding 4 is made from memory foam, enabling the padding 4 to change its structural shape subject to user's body temperature. More specifically, this means that the padding 4 is responsive to receiving changes in objects subject to the present invention's support.

In another aspect, the thermo-pressing apparatus 5 includes a male binding member 51 and a female binding member 52, wherein the female binding member 52 has a flat surface 521, and one surface of the male binding member 51 has a plurality of grooved regions 511, wherein each of which has a size corresponding a padding 4. The male binding member 51 and the female binding member 52 compress against each other when the thermo-pressing process is underway, where the male binding member 51 moves in such a way to act on the first major surface 11 of the covering sheet 1, while the female binding member 52 moves in a directly opposite way to act on the first major surface 21 of the non-slip sheet 2. After the pressing process is performed a plurality of thermo-binding lines or regions 111 having geometric patterns are created on the first major surface 11 of the covering sheet 1, while in the same time as the padding 4 pushes upward against the covering sheet 1 and the topping sheet of cushioning material 4 to produce an internal pocket 112 outlining the neighboring thermo-binding lines or regions 111

Furthermore, the padding 4 described herein is arranged partially between the topping sheet of cushioning material 3 and the substrate sheet of cushioning material 9, therefore is lighter in weight and is easy to carry.

The reader will appreciate that the aforementioned support device could be further processed to be configured for use in various occasions, including but not limited to, mattress topper, seat cushion, or couch cushion.

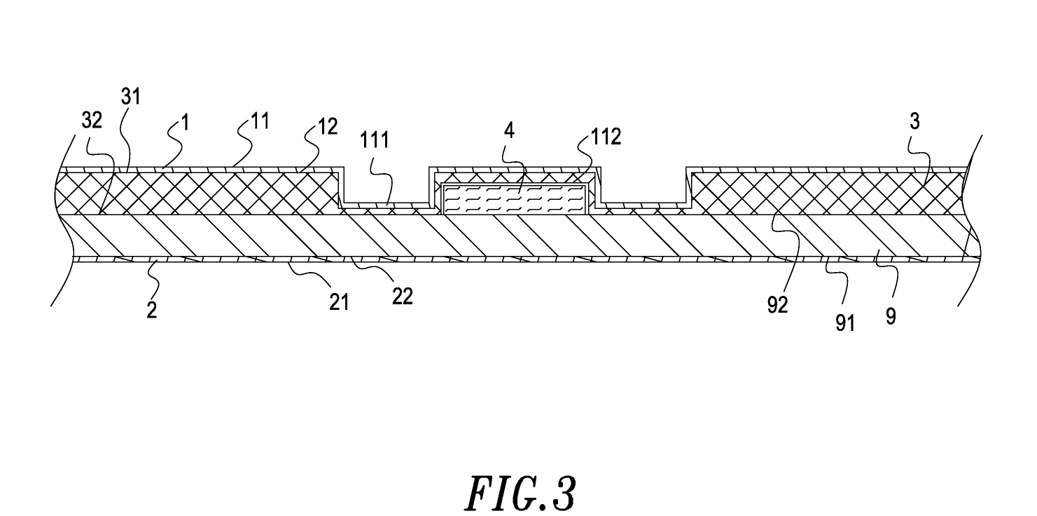

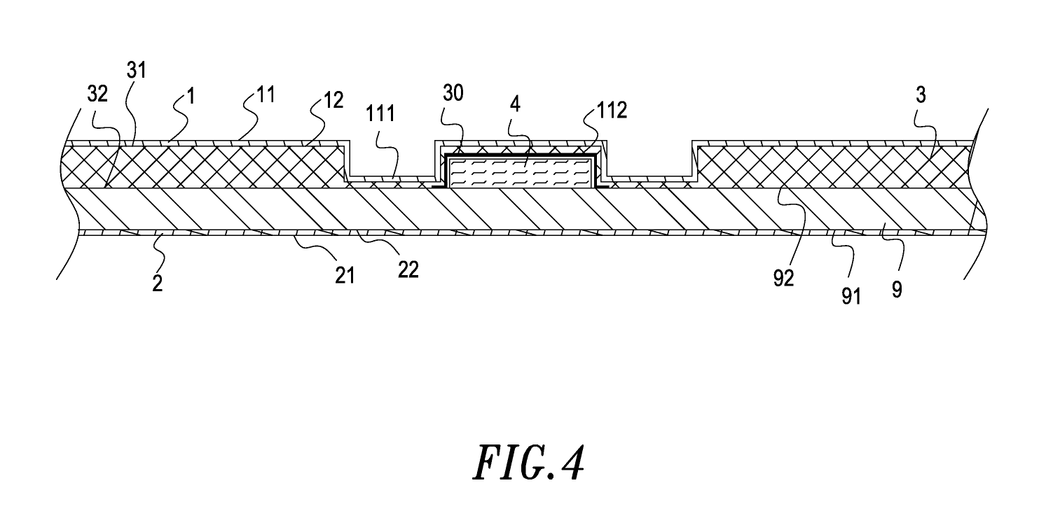

Referring now to FIG. 4, there is shown a cross-sectional perspective view of the thermo-pressed cushioning support device in a second preferred embodiment. The reader will appreciate that a difference between FIG. 3 and FIG. 4 gives way to resolve a likely problem taking into account a possibility wherein the constituting materials making up the padding 4, which in this case are gels or other greasy materials, are subject to leaking out undesired grease residues to areas including the topping sheet of cushioning material 3. To this end, a solution offered herein in FIG. 4 provides that there be inserted a thin film layer 30 between the padding 4 and the topping sheet of cushioning material 3. The thin film layer 30 is expected to cover the padding 4 on its sides, thereby preventing grease originating from the padding 4 to pass on to reach the topping sheet of cushioning material 3.

In one aspect of the second preferred embodiment of the present invention, the thin film layer 30 can configured to cover the padding 4 completely prior to having the padding 4 placed within the internal pocket 112.

In one notable aspect, the thin film layer 30 is made from thermoplastic polyurethane (TPU) thin film or polyethylene (PE) thin film.

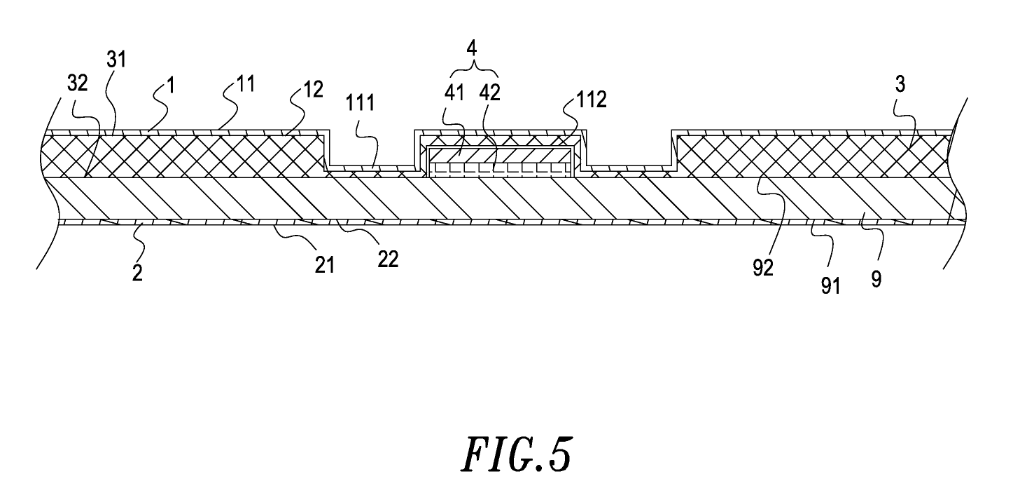

Referring now to FIG. 5, there is shown a diagrammatic view of a third embodiment of the thermo-pressed cushioning support device. The reader will appreciate that a difference between FIG. 3 and FIG. 4 points to an inclusion of a stack with a shock absorbing compound 41 overlaying upon a modeling compound 42, which instills in the padding 4 functionalities including but not limited to ability to support, absorb vibration, disperse external pressure, buffer impact, and transform in response to heat.

In one notable aspect, the shock absorbing compound 41 is made from gels, latex, silica gels, or other elastomeric materials. The modeling compound 42 can be made from memory foam. In practice, implementation of the foregoing materials can be realized in ways including one wherein the shock absorbing compound 41 provides a means to take in tension and distributively transfer the tension, and further the modeling compound 42 transforms its shape in response to elevated temperature. Accordingly, this can provide desired benefits to the present invention, including comfort support and tension reduction around a user's neck, back, waist, and legs portion when the thermo-pressed cushioning support device is applied into furniture including but not limited to mattress topper, seat cushion, or back cushion.

In another aspect, the relative position of the shock absorbing compound 41 and modeling compound 42 within a stack having both compounds is receptive to change upon demand.

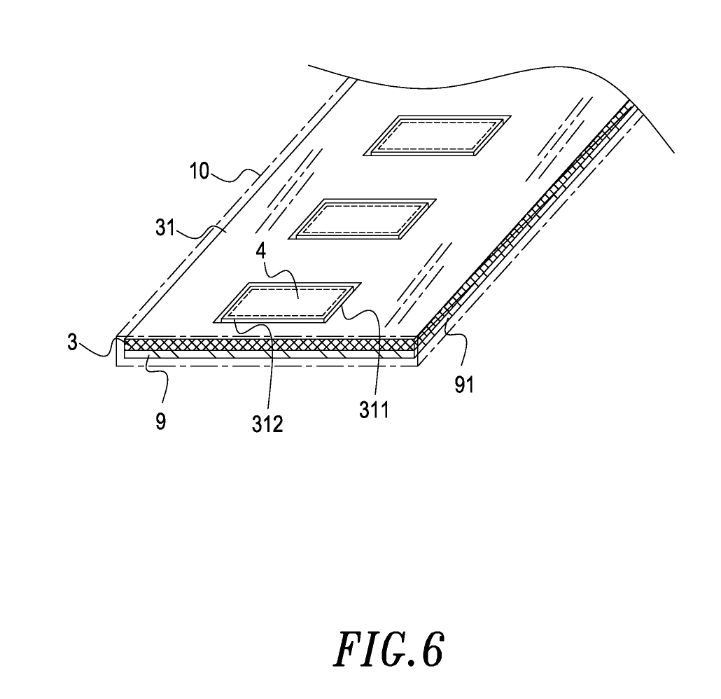

Referring now to FIG. 6, there is shown a diagrammatic view of the fourth embodiment of the thermo-pressed cushioning support device. The reader will appreciate that a difference between FIGS. 1-5 and the foregoing figure is that the first major surface 31 of the topping sheet of cushioning material 3 is not attached to the covering sheet 1, and also that the second major surface 92 of the substrate sheet of cushioning material 9 is not attached to the non-slip sheet 2. Accordingly at least one thermo-binding line or region 311 is formed on the first major surface 31 of the topping sheet of cushioning material 3 when the topping sheet of cushioning material 3 is thermally engaged with the substrate sheet of cushioning material 9, thereby also creating an internal pocket 312 wherein a padding 4 is stored. Lastly, a wrapping layer 10 can be introduced to encase a padding 4 laden topping sheet of cushioning material 3 as well as the substrate sheet of cushioning material 9. The bottom surface of the wrapping layer is outfitted with a slip stopping layer for preventing slipperiness.

In a notable aspect, the padding 4 is made from fabric, linen, or leather.

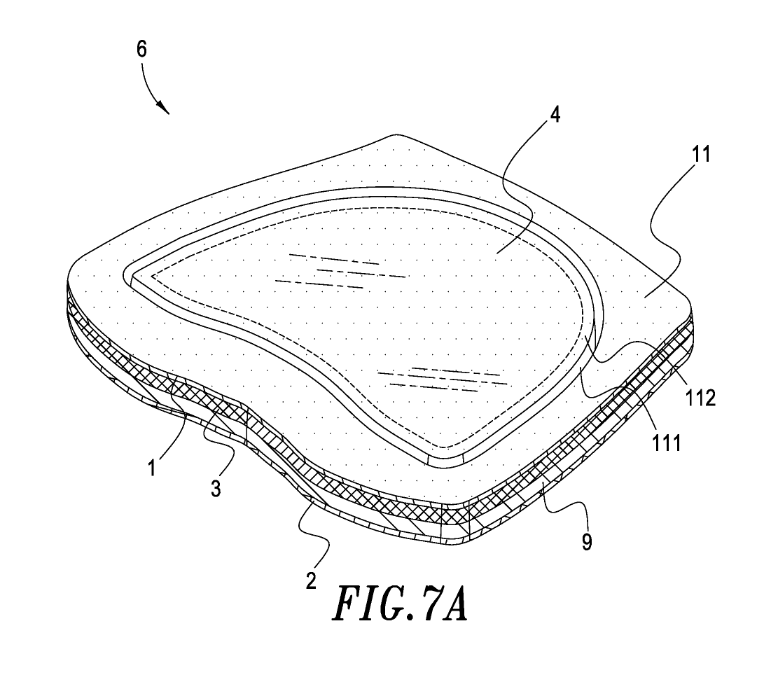

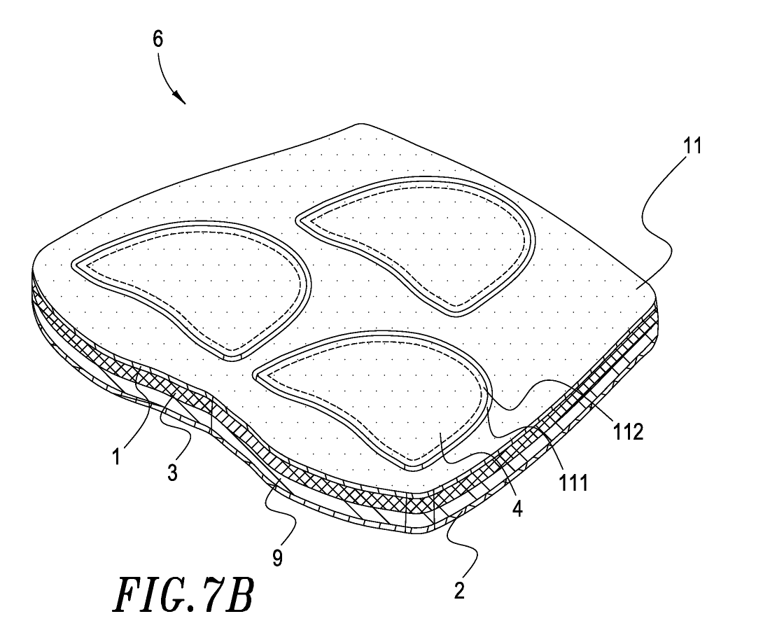

FIGS. 7A, 7B show perspective views of the thermo-pressed cushioning support device structured in a form of seat cushion. The reader will appreciate that the thermo-pressed cushioning support device of the present invention can be formed into a seat cushion configuration. In this embodiment of the invention, one thermo-binding lines or regions 111 on the covering sheet 1 is formed around the neighborhood of the padding 4 on the surface of the seat cushion 6 (as illustrated in FIG. 7A) or a plurality of thermo-binding lines or regions 111 on the covering sheet 1 are formed around the neighborhood of the padding 4 on the surface of the seat cushion 6 (as illustrated in FIG. 7B); the foregoing configurations allow one or a plurality of internal pockets 112 to be created on the covering sheet 1 of the seat cushion 6. Each internal pocket 112 created therein encloses within itself a padding 4, the padding 4 is configured in a prescribed way to receive a user's thigh bones (i.e. femurs) and hip bones (i.e. coxal bones). Accordingly, the present invention operates to support a user's weight with the topping sheet of cushioning material 3 and the substrate sheet of cushioning material 9 when the user is a repose position; the reader will also appreciate that the installment of one or a plurality of padding 4 and internal pockets 112 can further provide support and buffer to the collision and tension brought upon by the user's thigh bone and hip hone.

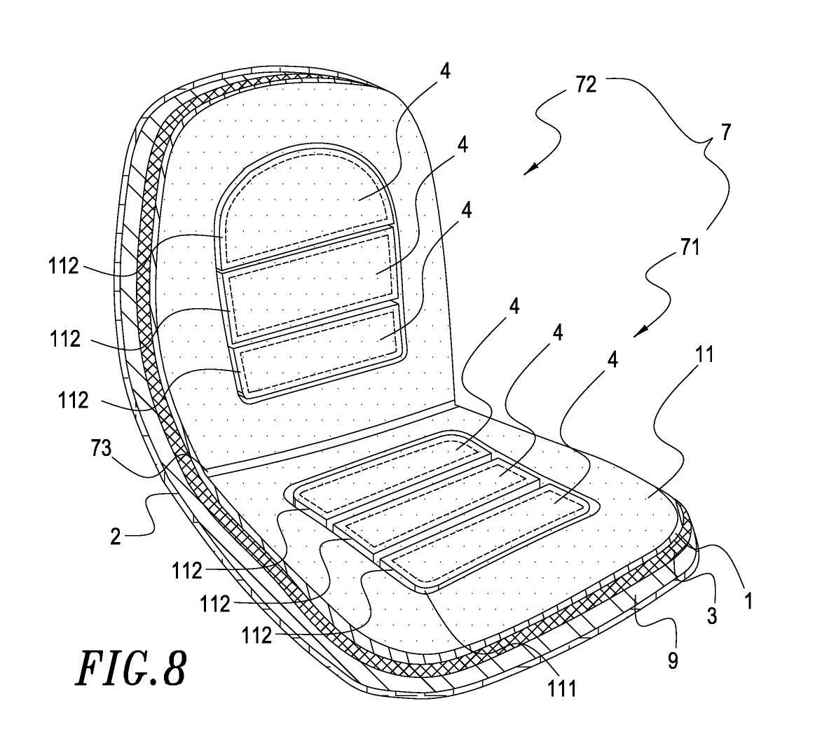

FIGS. 4, 5 should be taken into account when referring to FIG. 8, which shows a perspective view of a couch cushion manufactured from the thermo-pressed cushioning support device. The foregoing figures show an embodiment of the implementation of the thermo-pressed cushioning support device in the form a couch cushion 7. The couch cushion 7 is composed of a seat portion 71 and a back portion 72. A plurality of thermo-binding lines or regions 111 having geometric patterns are formed around the neighborhood of the padding 4 on the surface of the seat portion 71 through a thermo-pressing treatment, and as well as a plurality of internal pockets 112. Each internal pocket 112 created therein encloses within itself a padding 4, the padding 4 is configured in a prescribed way to receive a user's two femurs and coxal bones; in addition, a plurality of thermo-binding lines or regions 111 having geometric patterns are formed around the neighborhood of the padding 4 on the surface of the back portion 72 through a thermo-pressing treatment, and as well as a plurality of internal pockets 112. Each internal pocket 112 created therein encloses within itself a padding 4, the padding 4 is configured in a prescribed way to receive a user's neck, waist, and back.

Accordingly, the reader will appreciate that the padding 4 can receive correspondingly a user's neck, back, waist, hip, and thigh when the user is in a sitting position and laying his or her back upon the back portion 72 of the couch cushion 7. As an objective of the present invention to provide comfort in scenarios such as a sitting condition, the tension and collision set off by the user's sitting down and laying upon the couch cushion 7 can be offset by the functionalities provided by the padding 4 and the internal pockets 112, including support, shock absorbance, tension reduction, and molding.

In a notable aspect, there is created a folding region 73 at the centre of the couch cushion 7 so as to separate between the seat portion 71 and the back portion 72. This allows the user the freedom to fold along the folding region 73 in such a configurable way such as an “L” shape to permit the user to sit on the seat portion 71 while also having his or her back inclined on the back portion 72.

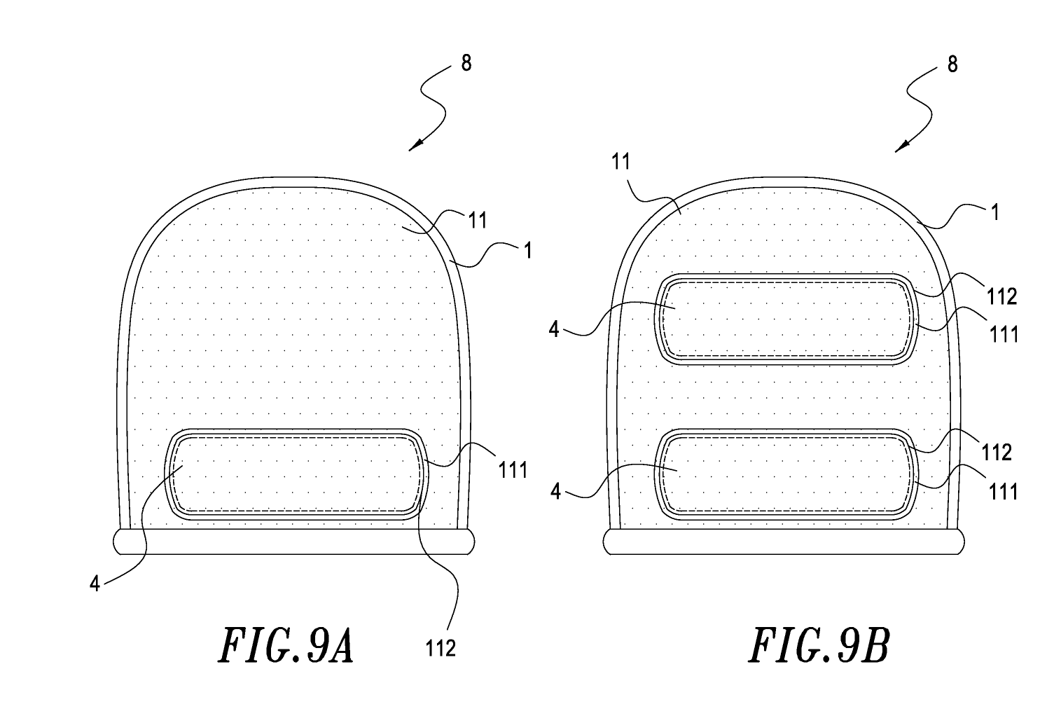

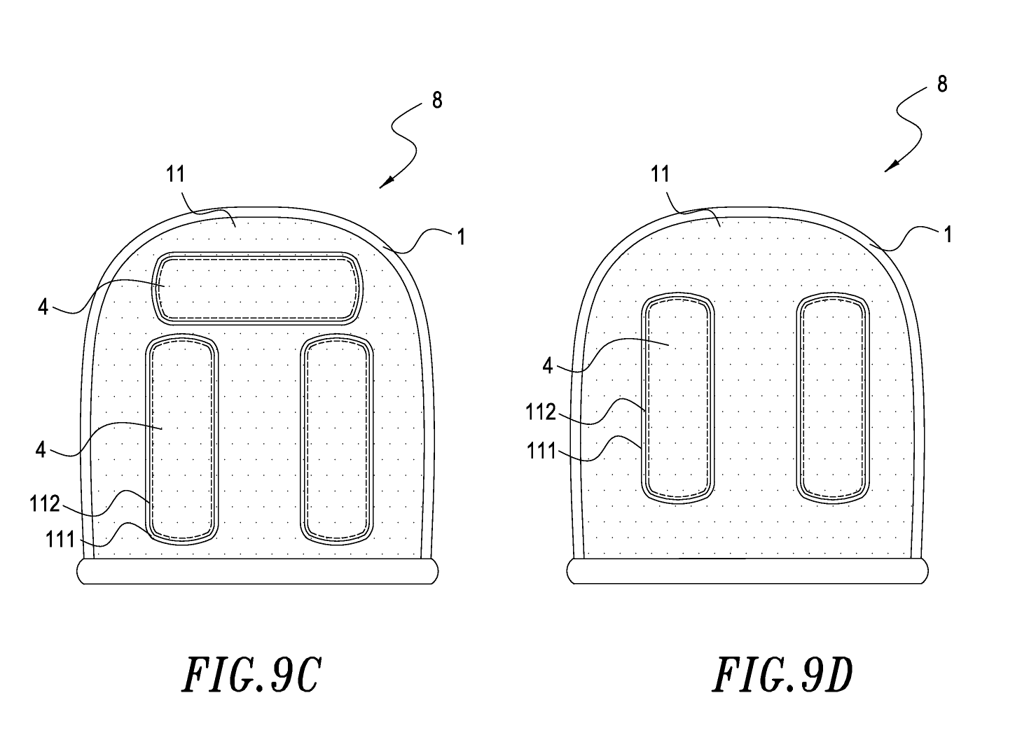

FIGS. 4, 5 should be taken into account when referring to FIG. 9A-9D, which present perspective views of various embodiments of back cushion manufactured from the thermo-pressed cushioning support device. The foregoing figures show embodiments illustrating the implementation of the thermo-pressed cushioning support device in the form of a back cushion 8. A plurality of thermo-binding lines or regions 111 having geometric patterns are formed around the neighborhood of the padding 4 on the surface of the back cushion 8 through a thermo-pressing treatment, and as well as a plurality of internal pockets 112. Each internal pocket 112 created therein encloses within itself a padding 4; as illustrated in FIG. 9A, internal pockets 112 can be created from the compression enforced at the portion of the back cushion 8 near the user's waist. Accordingly, the reader will appreciate the benefits of the impact-buffering and shape modeling of the padding 4 and the corresponding internal pocket 112 as observed in the user's relief from the tension and collision perceived at his or her waist when the user is in a sitting position.

As illustrated in FIG. 9B, padding 4 and internal pockets 112 are created near the user's waist and near the user's upper back portion. Accordingly, the reader will appreciate the benefits of the impact-buffering and shape modeling of the padding 4 and the corresponding internal pocket 112 as observed in the user's relief from the tension and collision perceived at his or her waist and upper back portion when the user is in a sitting position.

As illustrated in FIG. 9C, padding 4 and internal pockets 112 can be created from the compression enforced at the portion of the back cushion 8 at the left and right sides to the user's spine as well as at the user's neck. Accordingly, the reader will appreciate the benefits of the impact-buffering and shape modeling of the padding 4 and the corresponding internal pocket 112 as observed in the user's relief from the tension and collision perceived at the left and right sides to the user's spine as well as at the user's neck when the user is in a sitting position.

As illustrated in FIG. 9D, padding 4 and internal pockets 112 can be created from the compression enforced at the portion of the back cushion 8 at the left and right sides to the user's spine. Accordingly, the reader will appreciate the benefits of the impact-buffering and shape modeling of the padding 4 and the corresponding internal pocket 112 as observed in the user's relief from the tension and collision perceived at the left and right sides to the user's spine when the user is in a sitting position.

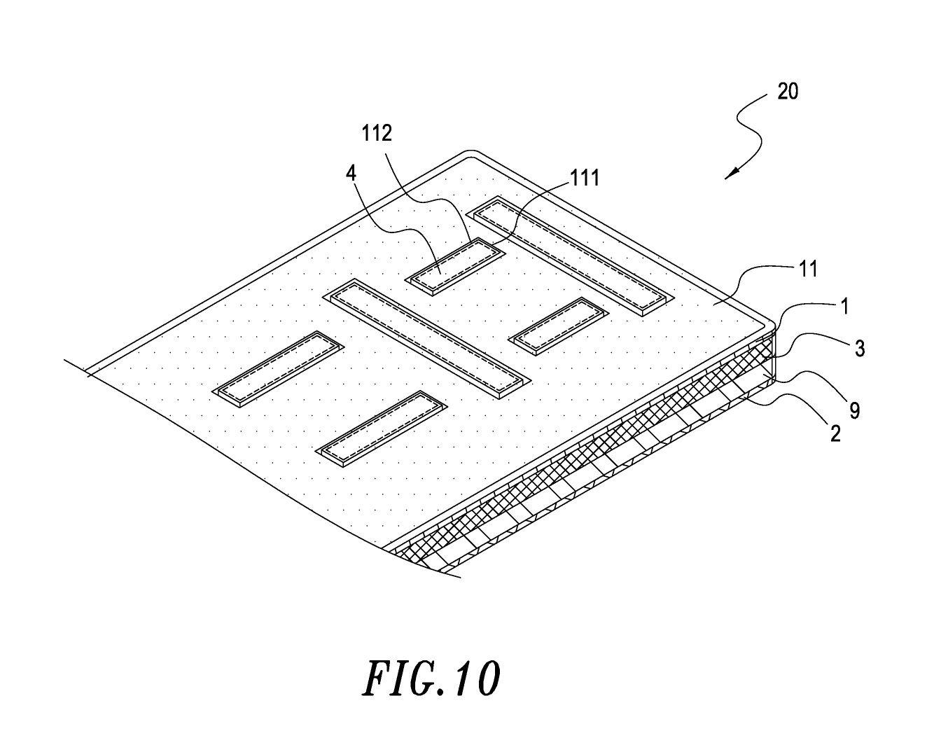

FIGS. 4, 5 should be taken into account when referring to FIG. 10, which presents a perspective view of an embodiment of mattress topper manufactured from the thermo-pressed cushioning support device. The foregoing figures show an embodiment of the implementation of the thermo-pressed cushioning support device in the form of a mattress topper 20. A plurality of thermo-binding lines or regions 111 having geometric patterns are formed around the neighborhood of the padding 4 on the surface of the mattress topper 20 through a thermo-pressing treatment, and as well as a plurality of internal pockets 112. Each internal pocket 112 created therein encloses within itself a padding 4, the padding 4 is configured in a prescribed way to receive a user's neck, two sides of the spine, waist, and thighs; accordingly, the reader will appreciate the benefits of the impact-buffering and shape modeling of the padding 4 and the corresponding internal pocket 112 as observed in the user's relief from the tension and collision perceived at his or her neck, two sides of spine, waist, thighs when the user is in a lying position.

In one aspect, the padding 4 described in FIGS. 7A, 7B, FIGS. 8A-8D, FIG. 9, and FIG. 10 can be composed solely of a shock absorbing compound 41, which is made from gels, latex, silica gels, or other elastomeric materials, or the padding 4 can be composed solely of modeling compound 42, which is made from memory foam, or the padding 4 can be composed a stack of the shock absorbing compound 41 and the modeling compound 42.

In one aspect, the thermo-binding lines or regions described above from FIG. 1 to 10 are preferred to be made within 1˜30 in numbers.

It is understood that the foregoing preferred embodiments of the present invention offers the following advantages over prior relevant technology:
1. The present invention uses a thermo-pressing treatment as a means to combine together a plurality of shock absorbing compound or modeling compound within the internal pockets housed between a topping sheet of cushioning material and a substrate sheet of cushioning material.
2. A covering sheet is applied upon the topping sheet of cushioning material. The covering sheet can be made from a fabric, allowing for higher marketability.
3. The topping sheet of cushioning material and the substrate sheet of cushioning material can be used as a storage pouch, and can be covered with a wrapping layer. The wrapping layer is detachable for cleaning.
4. The thermo-pressing treatment from which the present invention is manufactured offers an enhanced means for adjoining the two sheets of cushioning materials, which is able to effectively avoid undesired dislocation of the padding.
5. The present invention is appropriate for use as mattress topper, seat cushion, or couch cushion and is customizable in terms of the placement and number of padding so as to correspond to user's body parts.

The preferred embodiment described above is provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A thermo-pressed cushioning support device, comprising:
a topping sheet of cushioning material having a first major surface and a second major surface;
a substrate sheet of cushioning material having a first major surface and a second major surface;
at least one padding attached onto a predetermined location situated between the second major surface of the topping sheet of cushioning material and the first major surface of the substrate sheet of cushioning material; and
at least one thermo-binding line or region configured in a generally geometric pattern and at least one internal pocket that substantially encloses the padding, wherein the thermo-binding line or region and the internal pocket are created in the topping sheet of cushioning material as a result of subjecting the topping sheet of cushioning material and the substrate sheet of material and the padding to a thermo-pressing treatment, wherein the topping sheet of cushioning material is tightly bonded to the substrate sheet of cushioning material at the thermo-binding line or region.

2. The thermo-pressed cushioning support device of claim 1 further comprising a wrapping layer, wherein the wrapping layer encases the topping sheet of cushioning material having the padding enclosed therein and the substrate sheet of cushioning material.

3. The thermo-pressed cushioning support device of claim 1, wherein the padding comprises a shock absorbing compound.

4. The thermo-pressed cushioning support device of claim 1, wherein the padding comprises a shape modeling compound.

5. The thermo-pressed cushioning support device of claim 1, wherein the padding comprises a stack of shock absorbing compound and a shape modeling compound.

6. The thermo-pressed cushioning support device of claim 1, wherein the topping sheet of cushioning material and the substrate sheet of cushioning material are combined and further configured to form a seat cushion, a couch cushion, a back cushion, or a mattress topper.

7. The thermo-pressed cushioning support device of claim 1 further comprising a thin film layer, wherein the thin film layer covers the padding.

8. A thermo-pressed cushioning support device, comprising:
a covering sheet, wherein the covering sheet has a first major surface and a second major surface;
a topping sheet of cushioning material, wherein the topping sheet of cushioning material has a first major surface and a second major surface, wherein the second major surface of the covering sheet is attached onto the first major surface of the topping sheet of cushioning material;
a non-slip sheet, wherein the non-slip sheet has a first major surface and a second major surface, wherein the first major surface of the non-slip sheet comprises a non-slip surface;
a substrate sheet of cushioning material, wherein the substrate sheet of cushioning material has a first major surface and a second major surface, wherein the second major surface of the non-slip sheet is attached onto the second major surface of the substrate sheet of cushioning material;
at least one padding attached onto a predetermined location situated between the second major surface of the topping sheet of cushioning material and the first major surface of the substrate sheet of cushioning material; and
at least one thermo-binding line or region configured in a generally geometric pattern and at least one internal pocket that substantially encloses the padding, wherein the thermo-binding line or region and the internal pocket are created in the topping sheet of cushioning material as a result of subjecting the topping sheet of cushioning material and the substrate sheet of material and the padding to a thermo-pressing treatment, wherein the topping sheet of cushioning material is tightly bonded to the substrate sheet of cushioning material at the thermo-binding line or region.

9. The thermo-pressed cushioning support device of claim 8, wherein the padding comprises a shock absorbing material.

10. The thermo-pressed cushioning support device of claim 8, wherein the padding comprises a shape modeling material.
